(19) United States
(12) Patent Application Publication
(10) Pub. No.: US 2006/0159048 A1
(43) Pub. Date: Jul. 20, 2006

(54) Method and software for controlling seamless vertical roaming

(76) Inventors: Sang-woo Han, Seoul (KR); Youn-pil Jeung, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/324,790

(22) Filed: Jan. 3, 2006

Related U.S. Application Data
(63) Continuation of application No. PCT/KR04/01628, filed on Jul. 2, 2004.

(30) Foreign Application Priority Data
Jul. 2, 2003 (KR) 10-2003-0044678

(51) Int. Cl. H04Q 7/00; H04Q 7/24

(52) U.S. Cl. 370/331; 370/338

(57) ABSTRACT

A method and program for controlling seamless vertical roaming between a wireless local area network and a wireless wide area network in a personal communication unit are disclosed. The method includes assigning an Internet Protocol (IP) address by a Foreign Agent (FA); transmitting a Mobile IP (MIP) request message to the FA; receiving a MIP advertisement message from the FA; transmitting a MIP registration request message to the FA; receiving the first MIP address from the FA; determining whether the personal information device has left a WLAN area (hot spot); if the personal information device has left the WLAN area, terminating an operation of the WLAN device and connecting a Point-to-Point Protocol (PPP) session with a Packet Data Serving Node (PDSN) within the WLAN using dial-up networking of the wireless modem at the same time; and receiving a second MIP address from the PDSN. The program is configured to operate the method in a computer or a processor.

### CROSS-REFERENCE TO RELATED APPLICATIONS

This application is a continuation under 35 U.S.C. § 365 (c) of International Application No. PCT/KR2004/001628 filed Jul. 2, 2004, designating the United States and claiming for the benefit of the earlier filing dates under 35 U.S.C. § 365 (b) of Korean Patent Application Nos. 10-2003-0044678 filed Jul. 2, 2003, which is hereby incorporated herein by reference in its entirety. International Application No. PCT/KR2004/001628 was published in English as WO 2005/004354 A1 on Jan. 13, 2005, which is hereby incorporated herein by reference in its entirety.

### BACKGROUND

1. Field

The present invention relates to a method of controlling seamless vertical roaming in a personal information device, which enables the seamless vertical roaming using a single control program in the personal information device equipped with a mobile communication modem and a wireless local area network device, and a recording medium that records the program.

2. Discussion of Related Technology

Recently, due to the mobility and convenience of the wireless Internet, the number of wireless Internet users is increasing. In particular, the Internet using a wireless solution has strong growth potential because it has advantages in that it has no spatial limitation and can be used while moving. Methods currently and most widely used are classified into a method using a mobile communication network and a method using a wireless Local Area Network (LAN). The two methods have advantages and disadvantages. That is, the mobile communication network has nationwide coverage, but is expensive to use. In contrast, the wireless LAN is inexpensive to use, but has a limited coverage area.

In order to overcome such limitations, service, which allows users to use a wireless LAN in a local area while using wireless data by combining a portable information terminal, such as a notebook computer or a Personal Digital Assistant (PDA), with a personal communication device, such as a mobile phone equipped with a Code Division Multiple Access (CDMA) mobile communication modem or a network access device equipped with a wireless LAN card, has been proposed. Conventional automatic seamless vertical roaming between a wireless LAN and a wireless wide area network for providing such service will be described with reference to FIGS. 1, 2 and 3.

FIG. 1 is a diagram schematically showing seamless vertical roaming that is the automatic switching of the logical connection between a Wireless Wide Area Network (WWAN), a Wireless LAN (WLAN) and a Wireless Personal Area Network (WPAN).

Referring to FIG. 1, a conventional seamless vertical roaming method provides seamless roaming between a Global System for Mobile communications (GSM)/GPRS (General Packet Radio Service) and a WLAN. Furthermore, the conventional method provides seamless roaming between the WLAN and the GSM/GPRS on the WLAN using Voice over Internet Protocol (VoIP) with respect to a wireless call. Furthermore, the above-described conventional method is constructed to determine whether a current area is a WLAN area using the signal intensity of the WLAN and automatically perform data access in the WLAN area.

In the above-described conventional method, the WWAN comprises mobile communication devices and network devices that are wirelessly coupled with each other throughout a wide geometrical area. Furthermore, the WWAN comprises a Cellular Digital Packet Data (CDPD) network, a GSM network and a GPRS network.

In the conventional method, the WLAN is a data communication system that is used to extend a wired local network or is alternative and flexible. The WLAN transmits and receives data over the air using Radio Frequency (RF) technology and minimizes the necessity for wireless connection. Furthermore, the WLAN combines data connectivity with user mobility. For this purpose, in the construction of a conventional WLAN, the access point of a transmitter, a receiver or a transceiver is constructed to connect with a fixed area using a standard cable on a wire network. The access point receives, buffers and transmits a minimum of data between the WLAN and the wire network.

In the conventional method, the WPAN refers to a Blue Tooth network. An end user accesses a WLAN through a WLAN adaptor. The WLAN adaptor is mounted in a notebook computer or palmtop computer in the form of a card. A palmtop computer and a desktop computer may be integrated into a pocket computer. The WLAN adaptor provides an interface between a client network Operating System (OS) and the air through an antenna. Wireless connection has the concept of transparency that refers to the property of using the network OS without the recognition of the existence thereof.

FIG. 2 is a drawing showing an example of a conventional WWAN. Referring to FIG. 2, an access point within the conventional WWAN is wirelessly linked to a plurality of WLANs 103 in buildings and spaces for public use. A gateway 105 connects the access point 101 to a GSM/GPRS network 115 via a public network, such as an Integrated Services Digital Network (ISDN) 107 or a Public Switched Telephone Network (PSTN) 109 and a mobile switching center gateway 113, or via the Internet 111.

Furthermore, in the conventional WWAN, a core network 115 comprises an operation maintenance center 117 for constructing traffic and loading the traffic to the network. Furthermore, the core network 115 comprises a Home Location Register (HLR) 119, a Visitor Location Register (VLR) 121 and a Certification Authority (CA) 123. The CA 123 stores information to be used for roaming, payment and network security. A mobile switching center 125 coupled with the mobile switching center gateway 113 is coupled with Base Station Controllers (BSCs) 127 and 129. Each of the BSCs 127 and 129 is coupled with at least one antenna 131, 133 or 135. The antennas 131, 133 and 135 are coupled with a variety of mobile communication devices 137, 139 and 141, such as wireless PDAs or smart phones, to provide broadband mobile Internet access. Each of the mobile communication devices comprises a common Subscriber Identity Module (SIM) used for WWAN and WLAN identification and a means for allowing the cross reference of payment information (not shown). A conventional WWAN comprises a Packet Control Unit (PCU), and a Gateway GPRS Support Node (GGSN) 145 and a Serving GPRS Support Node (SGSN) 147 that function as a GPRS support node and support GPRS communications on a standard GSM network.

Furthermore, the conventional mobile communication devices 137, 139 and 141 comprise portable dual mode wireless devices. Each of the portable dual mode wireless devices is set to allow the user to communicate with the WWAN through one of the WLAN and the antenna via an access point according to the intensity of a measured signal. Furthermore, the dual mode wireless device may be constructed to communicate with a Blue Tooth user.

FIG. 3 is a diagram showing a conventional seamless vertical roaming process. Referring to FIG. 3, seamless vertical roaming from a WWAN to a WLAN is prepared in such a way that a call is initiated between a WWAN wireless device 152 and a mobile communication device 155. When the subsystem of a dual mode wireless device 151 requests roaming, a WLAN wireless device 153 transmits a regular call to the WWAN wireless device 152 via a WLAN gateway 157, Mobile Switching Centers (MSCs) 159 and 161, a BSC 163 and a Base Transceiver System (BTS) 165.

Next, the WWAN wireless device 152 recognizes call standby and automatically receives the call by consenting to the current connection. Thereafter, the WLAN wireless device 153 is coupled with the traffic between a mobile communication device 155 and the WWAN wireless device 152. Then the dual mode wireless device 151 becomes aware of the connection, and releases the connection of the WLAN wireless device 153. Meanwhile, if the WLAN wireless device 153 is in an accessible state when the connection of the WLAN wireless device 153 is released, the WLAN gateway 157 maintains the accessible state.

In the meantime, a recent IMT-2000 communication network provides service, which accommodates existing IP (simple IP) and a Mobile IP (MIP), to provide Internet service. Network access service using the existing IP is performed in such a way that a mobile subscriber is assigned an existing IP address through a PDSN (FA) or an AAA server at a fixed location within a single BTS cell and accesses the Internet or a private network using the temporary IP address. If a mobile communication device accesses the private network, the mobile communication device must be operated with Virtual Private Network (VPN) software installed thereon.

Network access service using MIP (MIP service) allows a mobile communication device to transmit and receive data while moving at the state of maintaining connection, allows the mobile communication device to internally hold the same IP address regardless of the location of the mobile communication device, and manages the location information data of the mobile communication device. That is, the MIP service refers to service that allows the same IP address to be used in different areas using an IP address registered in a Home Agent (HA), so that the same service as in a home area can be continuously provided without discontinuity. The MIP is described with reference to FIGS. 4 and 5.

FIG. 4 is a diagram showing a data transmission and authentication process in the MIP. Referring to FIG. 4, when a Mobile Node (MN) moves to some other network and registers with a Foreign Agent (FA), the FA assigns an IP address, which will be temporarily used, to the FA. A datagram to be transmitted to the MN is encapsulated by the HA and then is transmitted to the FA through the tunnel from the HA to the FA. After the FA has received the datagram, the FA decapsulates the datagram and transmits the decapsulated datagram to the MN.

In this case, the encapsulation refers to a method of temporarily reassigning the address of an IP datagram to transmit data to a destination, and is also called tunneling. The transmission and authentication of data comprise processes of obtaining approval after passing through an authentication process in the AAA server via the PDSN (FA), transmitting data from the PDSN (FA) to the PDGN (HA) and accessing the Internet or an intranet when the MN transmits a signal.

In the meantime, the above-described MN refers to a client device that can move to an access point (base station) without changing its own IP address. The client device comprises a mobile terminal function. Furthermore, the tunnel refers to a route that is formed between the FA and the HA through a process of authenticating the MN. The datagram refers to a single packet that comprises transmission information for transmitting information routed through a packet network. The HA performs a function of encapsulating a datagram so as to achieve connection at the time of moving from a current subset to a different subset while maintaining a table for mobility bindings. The FA performs a termination point function of forming a virtual tunnel to allow the MN to enter its own subset when the MN moves to a new base station.

FIG. 5 is a diagram illustrating a mobility binding process for MIP. Referring to FIG. 5, the MIP service comprises a process of setting a temporary IP address and performing routing using a binding table to guarantee mobility. For example, the IP address of the MN, which a base station A (10.3.1.1) is assigned by the HA, is 1.1.1.3. When the MN moves to a base station B (10.31.2.1), the base station B (10.31.3.1) is reassigned the IP address (1.1.1.5) of the MN by the HA. When the MN moves to a base station C (10.31.3.1), the base station C (10.31.3.1) is reassigned the IP address (1.1.1.7) of the MN by the HA.

In this case, since the HA manages the IP address to be reassigned to the MN using a binding table, that is, the mobility binding table 201, the HA guarantees mobility or handoff by transmitting data to a recently registered base station. The mobility bindings of the MIP service are managed by the table 201 that is formed by combining the addresses of MNs with Care Of Addresses (COAs). The information on the locations to which the MN moves and addresses that are assigned to the MN is stored in the mobility binding table 201. Meanwhile, in the MIP service, a trie routing problem occurs in the transmission from an external node to the MN, so that a method, such as binding cache, smooth handoff or special tunneling, is used to solve the problem.

As described above, there is an advantage in that the user, who uses the personal information device equipped with the CDMA modem and the WLAN device, is provided with the environment in which the user can access the Internet using an inexpensive WLAN in a WLAN area and the CDMA modem in other areas.

However, the conventional seamless vertical roaming service must comprise access programs for driving a WWAN wireless device and a WLAN wireless device, respectively, to drive the WWAN wireless device and the WLAN wireless device, respectively. Furthermore, the CDMA mobile communication network access program used for the conventional WWAN can perform only processing for the CDMA modem, and can perform only the processing of simple IP. That is, it is impossible to process the MIP on the OS level of the conventional information device. Furthermore, the above-described problem also occurs in the WLAN. The conventional WLAN access program supports only existing IP (simple IP). Furthermore, since a specific WLAN access program is separately provided in addition to a driver for a corresponding WLAN card, it is difficult to use the specific WLAN access program in different WLANs.

Meanwhile, in the case of using the MIP, the first assigned IP address can be used regardless of movement to any network, so that Internet service using the UDP protocol, such as Video On demand (VOD) service, can be used without discontinuation at the time of accessing the Internet. For example, most Internet sites are constructed to close a session and request login when an IP address is changed while the user is logged in. Such problems can be solved using MIP. In this case, in order to use the MIP, a CDMA modem, a WLAN card and drivers provided by manufacturers are installed on a personal information device and the CDMA modem and the WLAN card are constructed to be controlled using an MIP execution program.

Furthermore, a conventional method using MIP has inconvenience in that a wireless data access client program for a mobile communication network and a wireless access client program for a WLAN must be separately used. Accordingly, a method or an apparatus capable of integrally using the above-described two methods through a single control client program in a personal information device is required.

### BRIEF DESCRIPTION OF DRAWINGS

FIG. 1 is a diagram schematically showing seamless vertical roaming that is the automatic switching of the logical connection between a WWAN, a WLAN and a WPAN;

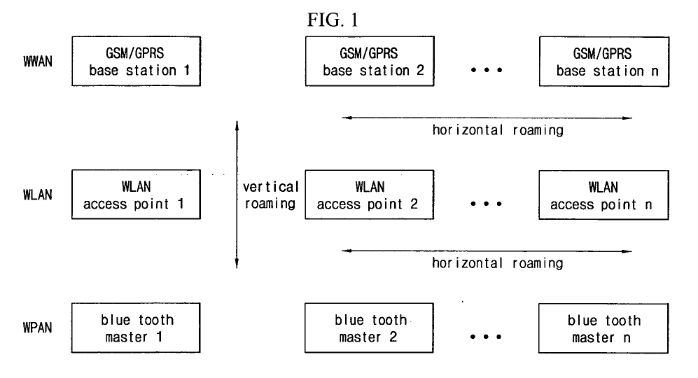

FIG. 2 is a drawing showing an example of a conventional WWAN;

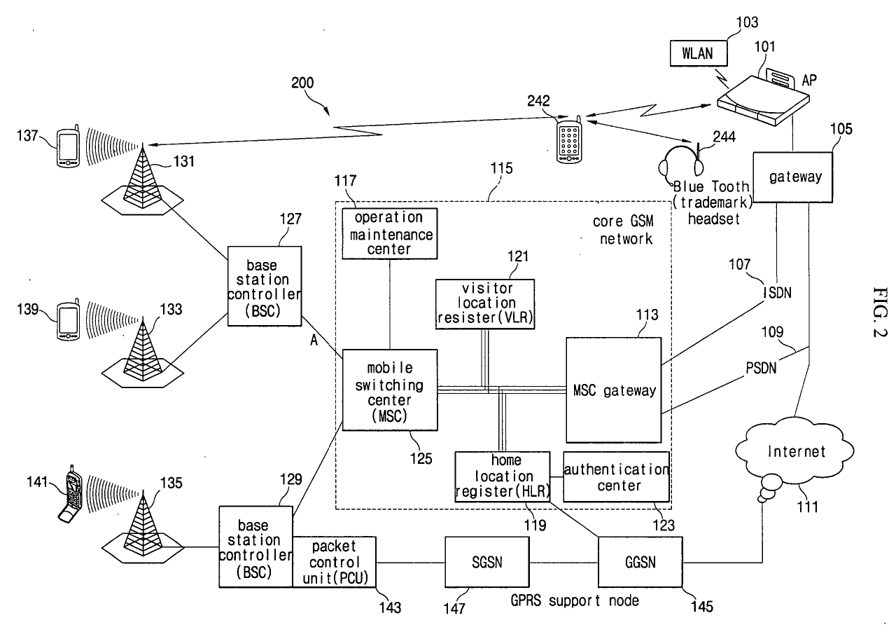

FIG. 3 is a diagram showing a conventional seamless vertical roaming process;

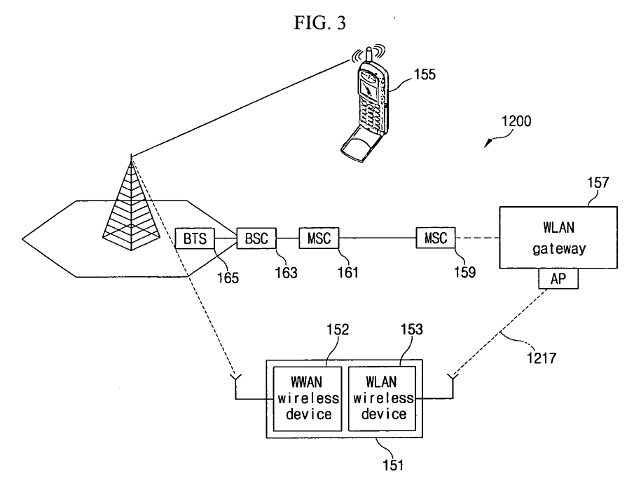

FIG. 4 is a diagram showing a data transmission and authentication process in the MIP;

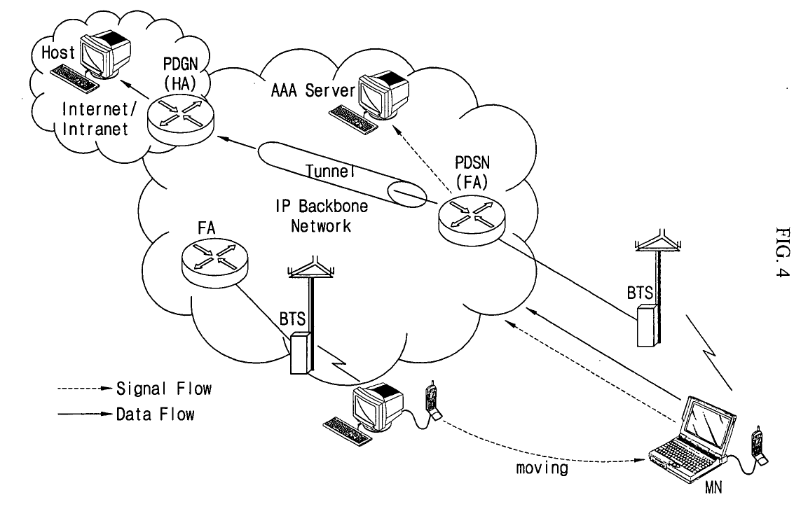

FIG. 5 is a diagram illustrating a mobility binding process for the MIP;

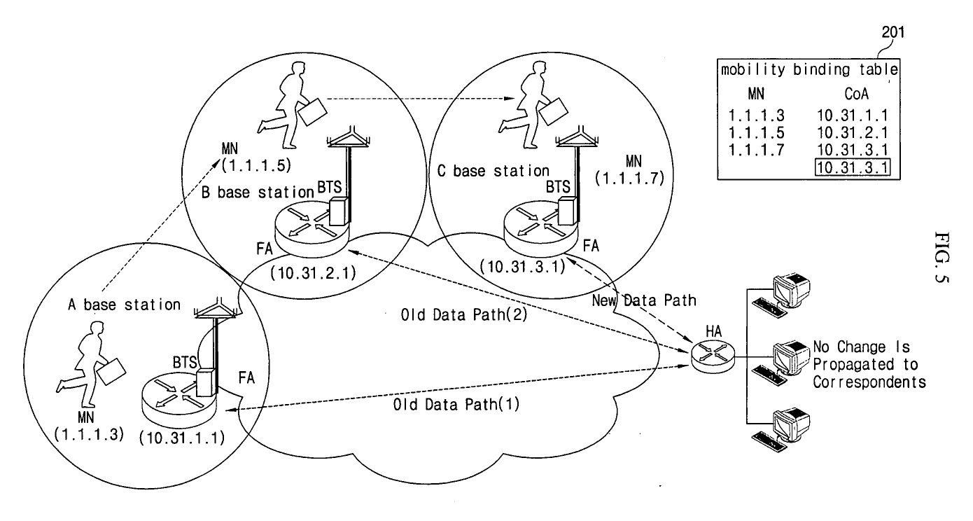

FIG. 6 is a diagram schematically showing the construction of a personal information device to which a seamless vertical roaming control method according to the preferred embodiment of the present invention can be applied;

FIG. 7 is a diagram schematically showing the user interface of an OS level application program in accordance with a preferred embodiment of the present invention;

FIG. 8 is a diagram showing a protocol stack for controlling the seamless vertical roaming of a personal information device in accordance with a preferred embodiment of the present invention;

FIG. 9 is a flowchart schematically showing a seamless vertical roaming method in a personal information device in accordance with a preferred embodiment of the present invention;

FIG. 10 is a flowchart schematically showing a process of vertical roaming from a WLAN to a CDMA network in accordance with a preferred embodiment of the present invention;

FIG. 11 is a flowchart schematically showing a process of vertical roaming from a CDMA network to a WAN in accordance with a preferred embodiment of the present invention;

FIG. 12 is a signal flow diagram showing a signal processing process related to seamless vertical roaming from a WLAN to a CDMA network in a preferred embodiment of the present invention;

FIG. 13 is a signal flow diagram showing a process of processing signals for MIP on the wireless network of FIG. 2;

FIG. 14 is a diagram showing a data format for a general IP in IP encapsulation process; and

FIG. 15 is a diagram showing a data format for a general minimum encapsulation process.

### SUMMARY OF CERTAIN INVENTIVE ASPECTS

Accordingly, an aspect of the present invention is to provide a method for providing seamless vertical roaming by integrally controlling a wireless modem and a WLAN device using a single control program in a personal information device equipped with the wireless modem for accessing a mobile communication network and the WLAN device for accessing a WLAN.

Another aspect of the present invention is to provide a control client program that is capable of providing seamless vertical roaming in the personal information device by integrally controlling a wireless modem and a WLAN device in a personal information device equipped with the wireless modem and the WLAN device.

In accordance with an aspect of the present invention, there is provided a method of controlling seamless vertical roaming in a personal information device equipped with a wireless modem and a Wireless Local Area Network (WLAN) device, including the steps of being assigned an Internet Protocol (IP) address by a Foreign Agent (FA) within an accessible WLAN using a Dynamic Host Configuration Protocol (DHCP) client, wherein the IP address is stored on a filter set on a physical layer and registered on a Domain Name Server (DNS) of the WLAN, which is currently being accessed, by the FA; transmitting a Mobile IP (MIP) request message to the FA; receiving an MIP advertisement message from the FA; transmitting an MIP registration request message to the FA, wherein the FA transmits the MIP registration request message to a Home Agent (HA) and receives a first MIP address from the HA; receiving the first MIP address from the FA, wherein the first MIP address is stored in the filter and the FA registers the first MIP address in the HA; determining whether the personal information device has left a WLAN area (hot spot); if, as a result of the determination, the personal information device has left the WLAA area, terminating an operation of the WLAN device and connecting a Point-to-Point Protocol (PPP) session with a Packet Data Serving Node (PDSN) within the WLAN using dial-up networking of the wireless modem at the same time; and receiving a second MIP address from the PDSN, wherein the second MIP address is assigned by the HA to correspond to the first MIP address and stored in the filter, and the PDSN registers the second MIP address in the HA.

In an embodiment, the filter is set by a control client program that integrally operates the wireless modem and the WLAN device. Furthermore, the filter controls headers of data packets or IP packets, which are transmitted and received between the FA or PDSN and the personal information device, between the physical layer and an upper layer above the physical layer. Furthermore, the filter comprises a WLAN filter and an MIP filter set on the physical layer.

Furthermore, an embodiment of the present invention further comprises the step of the FA or PDSN requesting access authentication from an Authentication, Authorization and Accounting (AAA) or home AAA (AAAh) and receiving a response thereto at the time of receiving the MIP registration request message.

In accordance with another aspect of the present invention, there is provided a method of controlling seamless vertical roaming in a personal information device equipped with a wireless modem and a WLAN device, including the steps of establishing a PPP session with a PDSN within a wireless network using dial-up networking; receiving an HA advertisement message from the PDSN; transmitting an MIP registration request message to the PDSN, wherein the MIP registration request message is transmitted to the HA through a foreign AAA (AAAf) and an internal AAA (AAAh); receiving an MIP registration reply message from the PDSN, wherein the MIP registration reply message comprises a first MIP address assigned by the HA, the first MIP address is stored in a filter set on a physical layer, and the PDSN registers the first MIP address in the HA; determining whether the personal information device exists in a WLAN area (hot spot) in a wireless network access state; if, as a result of the determination, the personal information device exists in the WLAN area, terminating an operation of the wireless modem and being assigned an available IP address from an FA within the WLAN using a DHCP client of the WLAN device at the same time, wherein the IP address is stored in the filter and is registered in a Domain Name Server (DNS) of the WLAN, which is being currently accessed, by the FA; and receiving a second MIP address from the FA, wherein the second MIP address is assigned by the HA to correspond to the first MIP address and stored in the filter, and the FA registers the second MIP address in the HA.

In an embodiment of the present invention, the filter is set by a control client program that integrally operates the wireless modem and the WLAN device. Furthermore, the filter controls headers of data packets or IP packets, which are transmitted and received between the FA or PDSN and the personal information device, between the physical layer and an upper layer above the physical layer. Furthermore, the filter comprises a WLAN filter and an MIP filter set on the physical layer. Furthermore, an embodiment of the present invention further comprises the step of the FA or PDSN requesting access authentication from an AAA or an AAAh and receiving a response thereto at the time of receiving the MIP registration request message.

In accordance with still another aspect of the present invention, there provided a computer readable recording medium having stored a computer executable control client program for integrally operating a wireless modem and a WLAN device to perform automatic seamless roaming between a wireless network and a WLAN, the control client program executing the steps of being assigned an IP address by an FA within an accessible WLAN using a DHCP client, wherein the IP address is stored on a filter set on a physical layer and registered on a DNS of the WLAN, which is currently being accessed, by the FA; transmitting an MIP request message to the FA; receiving an MIP advertisement message from the FA; transmitting an MIP registration request message to the FA, wherein the FA transmits the MIP registration request message to an HA and receives a first MIP address from the HA; receiving the first MIP address from the FA, wherein the first MIP address is stored in the filter and the FA registers the first MIP address in the HA; determining whether the personal information device has left a WLAN area (hot spot); if, as a result of the determination, the personal information device has left the WLAA area, terminating an operation of the WLAN device and connecting a PPP session with a PDSN within the WLAN using dial-up networking of the wireless modem at the same time; and receiving a second MIP address from the PDSN, wherein the second MIP address is assigned by the HA to correspond to the first MIP address and stored in the filter, and the PDSN registers the second MIP address in the HA.

In accordance with still another aspect of the present invention, there provided a computer readable recording medium having stored a computer executable control client program for integrally operating a wireless modem and a WLAN device to perform automatic seamless roaming between a wireless network and a WLAN, the control client program executing the steps of establishing a PPP session with a PDSN within a wireless network using dial-up networking; receiving an HA advertisement message from the PDSN; transmitting an MIP registration request message to the PDSN, wherein the MIP registration request message is transmitted to the HA through an AAAf and an AAAh; receiving an MIP registration reply message from the PDSN, wherein the MIP registration reply message comprises a first MIP address assigned by the HA, the first MIP address is stored in a filter set on a physical layer, and the PDSN registers the first MIP address in the HA; determining whether the personal information device exists in a WLAN area (hot spot) in a wireless network access state; if, as a result of the determination, the personal information device exists in the WLAN area, terminating an operation of the wireless modem and being assigned an available IP address from an FA within the WLAN using a DHCP client of the WLAN device at the same time, wherein the IP address is stored in the filter and is registered in a DNS of the WLAN, which is being currently accessed, by the FA; and receiving a second MIP address from the FA, wherein the second MIP address is assigned by the HA to correspond to the first MIP address and stored in the filter, and the FA registers the second MIP address in the HA.

In accordance with an embodiment of the present invention, the connection between heterogeneous networks can be performed using a single program installed on a mobile information device. In accordance with an embodiment of the present invention, when a user executes a client program, a client can make access after determining whether a current existing network is a mobile communication network or a WLAN. Accordingly, a user can more conveniently access a wireless data network and use wireless data service. In accordance with an embodiment of the present invention, there can be provided a heterogeneous network access program, which allows an appropriate network to be automatically obtained by providing a function of obtaining a desired network by the selection of the user or a function of automatically obtaining a mobile communication network area or a WLAN area.

### Detailed Description of Embodiments

Embodiments of the present invention are described in detail with reference to the accompanying drawings.

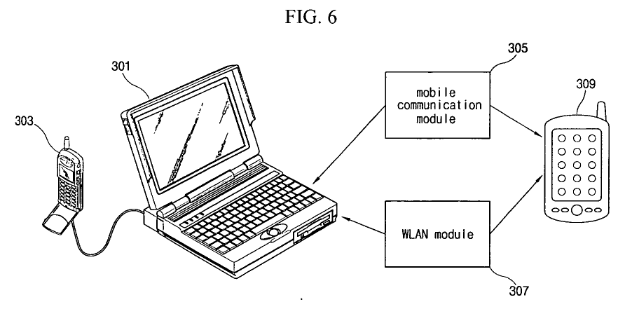

FIG. 6 is a diagram schematically showing the construction of a personal information device to which a seamless vertical roaming control method according to an embodiment of the present invention can be applied.

Referring to FIG. 6, the personal information device according to the embodiment comprises a notebook computer 301 to which a mobile communication terminal 303 is connected. The personal information device may comprise the notebook computer 301 or a PDA 309 equipped with a mobile communication module 305 and a WLAN module 307. The personal information device further comprises a control client program for driving the mobile communication module 305 and the WLAN module 307. Meanwhile, the mobile communication module 305 and the WLAN module 307 may be of external types, and may be combined with the personal information device, such as the notebook computer 301 or PDA 309, via an interface, such as a PCMCIA, USB or Serial Port.

As described above, in the embodiment of the present invention, it is possible for the personal information device equipped with the mobile communication modem and the WLAN device to access a WAN or WLAN using a single access program. Furthermore, in the present invention, the WAN and the WLAN can not only be accessed, but seamless vertical roaming can also be controlled.

That is, in accordance with the conventional method, in the area where only a mobile communication network exists, the mobile communication network is accessed using a mobile communication modem, the access program of the mobile communication module or dial-up networking. In contrast, in the area where a WLAN exists, the WLAN is accessed if authentication is not necessary, and the WLAN is accessed via a dedicated access program if authentication is necessary. However, in accordance with an embodiment of the present invention, the access program for the mobile communication modem and the access program for the WLAN device are integrated together, so that the two devices are integrally controlled using a single control program. With this construction, the handoff between heterogeneous networks can be easily performed. Furthermore, in the case of a WLAN area, the signal of the access point of a WLAN is periodically detected and the automatic access from a mobile communication network to the WLAN is enabled. Furthermore, when service, such as MIP or IPv6, is initiated, integrated application with respect to such service is enabled. Furthermore, in accordance with an embodiment of the present invention, the status of the WLAN and the mobile communication network can be directly ascertained through a user interface for seamless vertical roaming service.

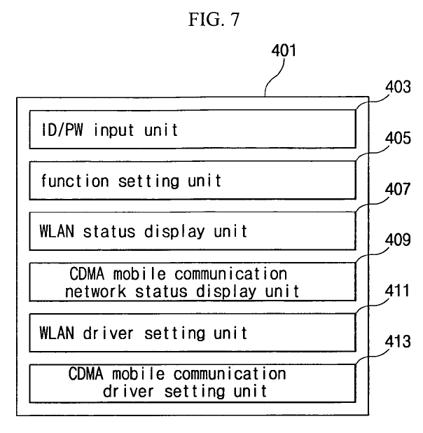

FIG. 7 is a diagram showing a user interface for seamless roaming service in accordance with an embodiment of the present invention. Referring to FIG. 7, a user interface 401 according to the embodiment of the present invention is composed of units for accommodating all network functions between heterogeneous networks. That is, the user interface 401 comprises an Identification (ID)/Password (PW) input unit 403, a function setting unit 405, a WLAN status display unit 407, a CDMA mobile communication network status display unit 409, a WLAN driver setting unit 411, and a CDMA mobile communication modem driver setting unit 413. The user interface 401 is the OS level application program of the personal information device, and chiefly takes charge of the setting of a WLAN filter and an MIP filter (modem filter).

The above-described ID/PW input unit 403 authenticates the authority of the personal information device or user on the OS level application program so that the personal information device can access a communication network. The function setting unit 405 comprises a subordinate menu for setting a variety of functions. For example, the subordinate menu comprises items and functions for an authentication method, an access method, function setting, WLAN card setting and mobile communication modem setting.

Furthermore, the WLAN status display unit 407 of the user interface 401 comprises a function of allowing the signal intensity of a WLAN and the status of SubSystem IDentification (SSID) to be displayed on the screen of the personal information device. The CDMA mobile communication network status display unit 409 comprises a function of allowing the signal intensity of a mobile communication network and the status of SSID to be displayed on the screen of the personal information device, like the WLAN status display unit 407. The WLAN driver setting unit 411 and the CDMA mobile communication modem driver setting unit 413 comprise functions of selecting and registering the WLAN driver or the mobile communication modem driver, respectively.

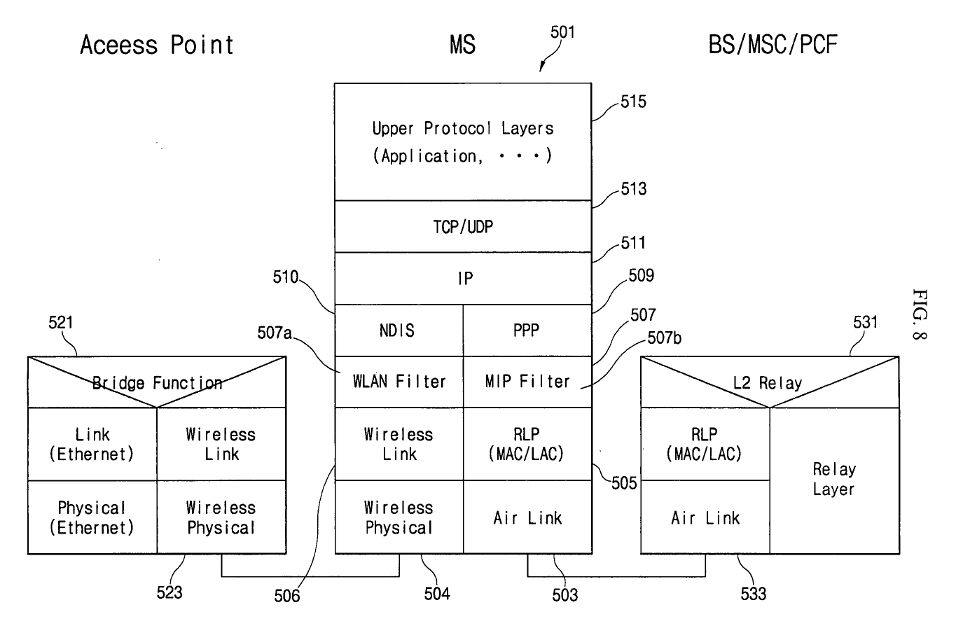

FIG. 8 is a diagram showing a protocol stack for controlling the seamless vertical roaming of a personal information device in accordance with an embodiment of the present invention. Referring to FIG. 8, a Mobile Station (MS) 501, which is the personal information device according to an embodiment of the present invention, comprises a filter 507 capable of controlling IP packets, which are to be transmitted to upper protocol layers, above a physical layer 503 and 504, more particularly a data link layer 505 and 506, in addition to a conventional basic protocol stack. In the embodiment, the filter 507 comprises a WLAN filter 507a coupled with the wireless physical layer 515 of an access point 521 on a WLAN side, and an MIP filter 507b coupled with the air link layer 533 of a BS/MSC/Point Coordination Function (PCF) on a WAN or mobile communication network side.

In the above-described protocol stack, the MIP filter 507b is located below a PPP layer 509 to take charge of a function of establishing a PPP session, as described in FIG. 8. With this construction, the MIP filter 507b takes charge of a modification/conversion function for IP and PPP packets. The WLAN filter 507a is located below a Network Driver Interface Specification (NDIS) layer 510, and takes charge of the functions of a Dynamic Host Configuration Protocol (DHCP) client also.

The reason for the construction is to allow a current personal information device to process the MIP because the MIP cannot be processed at the OS kernel stage of the personal information device. That is, the general processing of the MIP can be implemented by adding some steps to a general process of processing the IP. However, the MIP cannot be processed in the network driver provided by the OS level of the personal information device. Accordingly, in the embodiment, the filters 507a and 507b are placed below the PPP/NDIS layer 509/510, and are caused to function to convert IP packets.

As described above, the filter 507 according to the embodiment performs various functions through the control of IP packets that are transmitted from the physical layer 503 and 504 and the data link layer 505 and 506 to the network layer 509 and 510, the transport layer 511, the session layer 513 and the upper protocol layers 515 or transmitted in the reverse direction. For example, if authentication has failed, use can be blocked by blocking packets, which are transmitted to the physical layer 503 and 504, using the filter. Furthermore, when the MIP or IPv6 is applied, packets based on different protocol stacks can be converted into corresponding packets. Through this function, a personal information device, on which a specific protocol stack, and an OS and an application program that do not support specific functions are installed, can be easily used in heterogeneous networks. Furthermore, in the case of an authentication function, the operation of an authentication protocol may be enabled by the filter 507 according to an embodiment of the present invention.

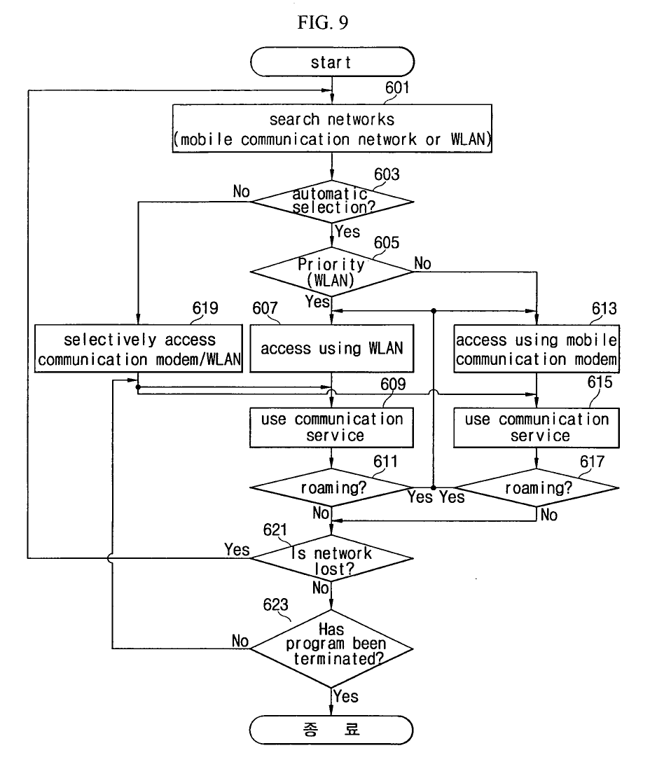

FIG. 9 is a flowchart schematically showing a seamless vertical roaming method in a personal information device in accordance with an embodiment of the present invention. Referring to FIG. 9, when a user, who uses the personal information device equipped with the mobile communication modem and the WLAN device, executes a network access program, the program searches networks and checks the status of a WLAN and a mobile communication network at step S601.

If the user sets the setting of the program to automatic selection at step 603, the program determines whether to access the mobile communication network or WLAN according to the priority set by the user. In the present embodiment, priority is set on the WLAN at step 605. In this case, if the signal of a selected network is short of a selection criterion, a lower priority network may be acquired. If only a mobile communication network or a WLAN exists, a corresponding network is acquired and accessed at steps 607 and 613.

If a roaming condition is fulfilled due to variations in the signal intensity of at least two networks while communication service is used through the mobile communication modem or WLAN device at steps 609 and 615, the horizontal roaming from the currently used network to the same network or vertical roaming from the currently used network to a different network is performed at steps 611 and 617. Meanwhile, if the currently used network is lost, the process restarts from the network search (step 601) at step 621. Meanwhile, if the network is not set to be automatically selected, the user may access a desired network by directly selecting the mobile communication modem or the WLAN at step 619. When the access program of the user is terminated, the operation of the program is terminated by log-off after a normal release process at step 623.

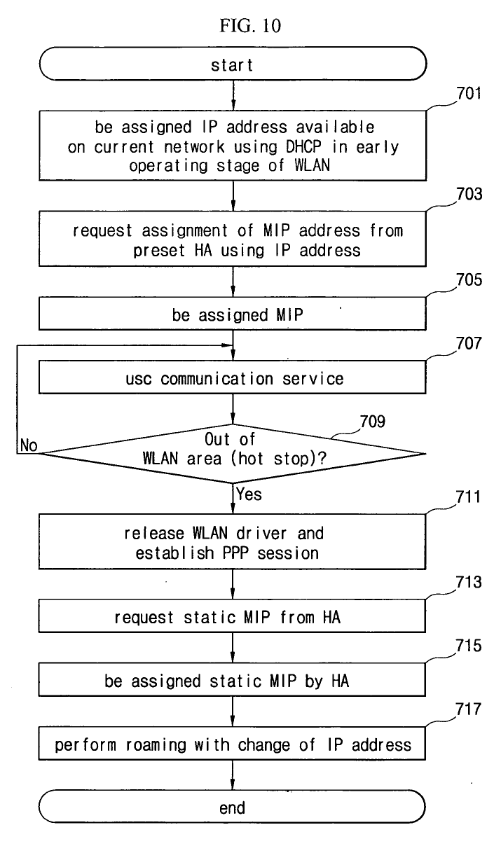

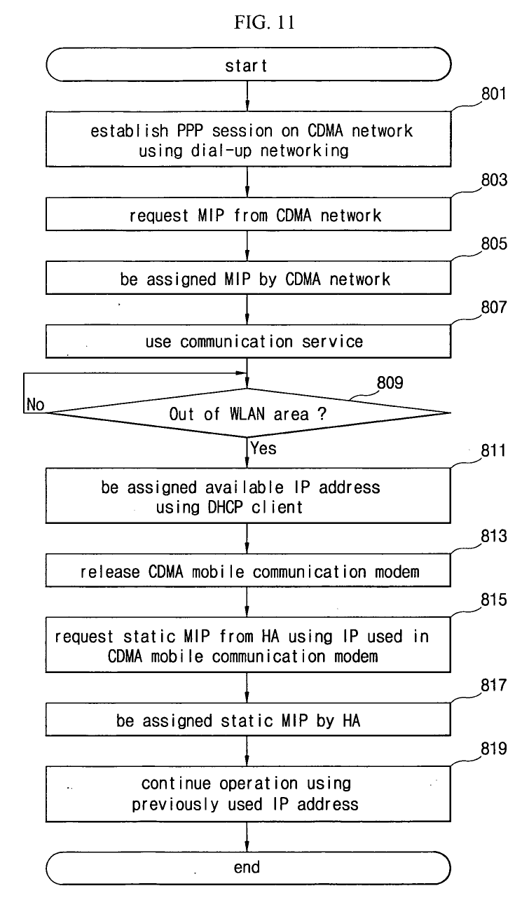

Next, roaming from the above-described WLAN to the mobile communication network and roaming in the reverse direction are described with reference to FIGS. 10 and 11. The below-described roaming algorithm of an embodiment the present invention is performed in such a way that a WLAN is automatically and preferentially accessed based on the signal intensity of an access point.

FIG. 10 is a flowchart schematically showing a process of vertical roaming from a WLAN to a CDMA network in accordance with an embodiment of the present invention. Referring to FIG. 10, the personal information device is assigned an IP address, which can be used in the current network, using a DHCP client at the time of the early operation of a WLAN at step 701. The assignment of an MIP address is requested from the HA that is preset in the program using the IP at steps 703. After the MIP is assigned by the HP, communication service, such as the Internet, is used at steps 705 and 707.

Thereafter, when leaving a WLAN area (hot spot) at step 709, the personal information device determines the operation of the WLAN driver and establishes a PPP session at step 711. Then an MIP address is requested from the HA at step 713. At this time, the request for the MIP is made in such a way as to request a static MIP address using the MIP address that was previously assigned by the WLAN. By this, the static MIP is assigned by the HA at step 715. Through the above process, the personal information device roams without a change of the IP from the point of view of the personal information device, that is, a terminal, at step 717.

Meanwhile, when the personal information device moves from a specific WLAN area to a different WLAN area, the operation of the WLAN driver is not terminated and automatic roaming can be achieved by restarting from the operation of the DHCP client and reregistering the MIP as in the process of FIG. 10.

FIG. 11 is a flowchart schematically showing a process of vertical roaming from a CDMA network to a WAN in accordance with an embodiment of the present invention. Referring to FIG. 11, like the process of FIG. 10, the roaming to the WLAN on the CDMA network starts from the step at which the personal information device establishes a PPP session using dial-up networking on the CDMA network at step 801. Thereafter, an MIP address is requested from the CDMA network, in particularly the HA coupled with the CDMA network, at step 803. Then the MIP address is assigned by the HA at step 805. Communication service is accessed using the assigned MIP address at step 807.

Thereafter, when moving to a WLAN area at step 809, the personal information device is assigned an IP address, which can be used on a corresponding network, using the DHCP client at step 811. When step 811 has been performed, the, CDMA is released at step 813. After the IP address has been assigned using the DHCP client, a static MIP address is requested from the HA, which was used in the CDMA modem, using the DHCP client at step 815. Then the static MIP is assigned by the HA at step 817. Through this process, the personal information device continuously performs the previous operation continuously using the previous IP address from the point of view of the personal information device at step 819.

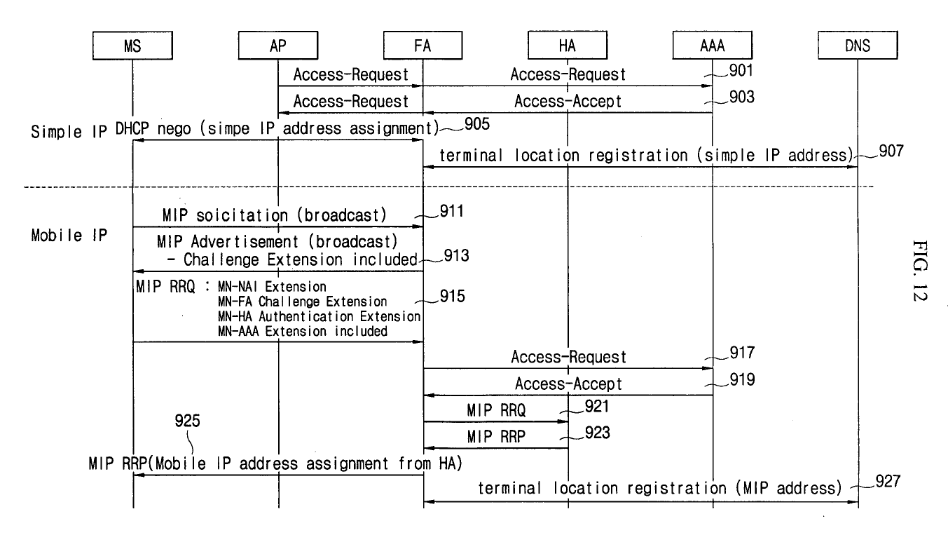

FIG. 12 is a signal flow diagram showing a signal processing process related to seamless vertical roaming from a WLAN to a CDMA network in an embodiment of the present invention. Referring to FIG. 12, when the personal information device approaches the AP, the AP transmits the access request message of the personal information device to the FA and the FA transmits the access request message to the AAA at step 901. The FA receives an access permission message and transmits the access permission message to the AP at step 903.

Thereafter, the personal information device is assigned a simple IP address, which can be used on a corresponding network, by the FA using the DHCP client at step 905. At this time, the FA registers the assigned simple IP in a Domain Name Server (DNS) at step 907. As described above, the simple IP address assignment is performed in such a way that the personal information device is authenticated by the AAA and then is assigned the simple IP address, which can be used on a corresponding network, through the DHCP client at steps 901 to 907.

Thereafter, in the personal information device according to an embodiment of the present invention, after call processing up to the step of being assigned the simple IP has been finished, the process enters the step of being assigned an MIP address. In particular, the personal information device transmits an MIP solicitation message to the FA at step 911. Then an MIP advertisement message is received from the FA at step 913. The personal information device transmits an MIP registration request message to the FA at step 915. Then the FA has gone through steps 917 and 919 of authentication with the AAA, the MIP address is assigned by the FA at steps 921 and 923, and the MIP address is transmitted to the personal information device at step 925. At this time, the FA registers the MIP address of the personal information device in the DNS at step 927.

As described above, the control client program or access program according to an embodiment functions to convert packets for processing the MIP after processing the simple IP. In particular, the above-described process of processing the MIP is added after the process of processing the simple IP. The above-described process of processing the simple IP is the part that is handled by the existing WLAN driver, and is processed without additional conversion or change in the filter. The filter acts appropriately and performs processing in the later MIP processing.

Furthermore, the IP address registered at the driver stage of the personal information device becomes an MIP address. Furthermore, the IP address received from the DHCP client is stored in the filter. With this construction, the MIP can be processed in the existing OS through a process of modifying the IP headers of all the data packets, which are transmitted in the MIP processing process, to fit the MIP protocol and a process of modifying packets that are transmitted through the FA.

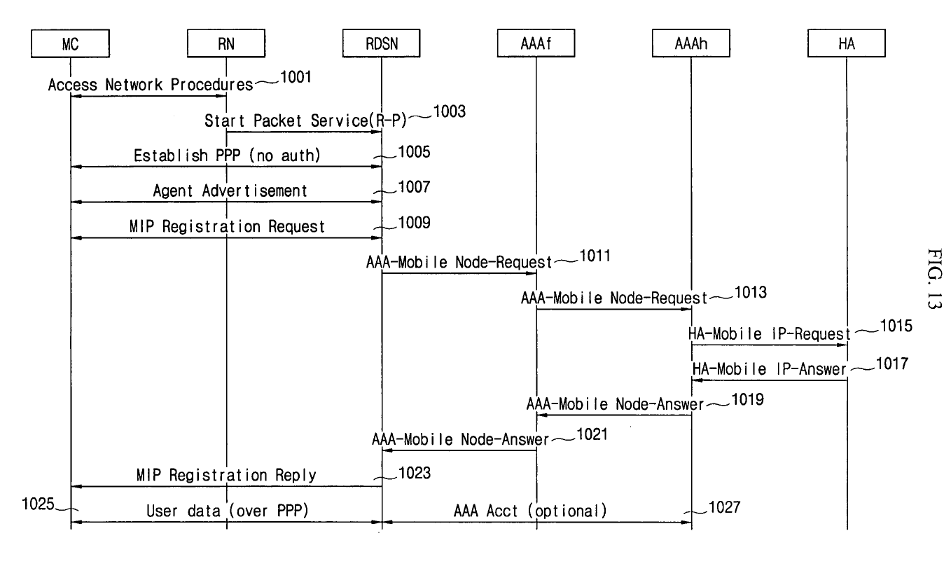

FIG. 13 is a signal flow diagram showing a process of processing signals for MIP on a CDMA network. Referring to FIG. 13, after the simple IP on the CDMA network establishes a PPP session through the LCP and the IPCP and an advertisement message is received, an MIP function is performed at steps 1001 to 1005. Since it is impossible for the existing mobile communication modem driver to process the function, the control client program modulates/creates packets to enable the MIP. The portion that is processed through the packet modulation in the filter part of the control client program according to an embodiment corresponds to all the steps (steps 1007 and 1027) from step 1007. This processing process is almost identical to the processing process in the WLAN in terms of a basic form.

That is, the MIP processing process following the establishment of the PPP session starts from the step, at which the Mobile Client (MC) receives an agent advertisement message from a Packet Data Serving Node (PDSN) through a Radio Network (RN), at step 1007, as shown in FIG. 13. The MC, which has received an HA address, transmits an MIP registration request message to the PDSN at step 1009.

Thereafter, the PDSN, which has received the MIP registration request message from the MC, transmits an AAA-mobile-node-request message to a foreign Authentication, Authorization and Accounting (AAAf) at step 1011. The AAAf transmits the AAA-mobile-node-request message to a home AAA (AAAh) at step 1013. The AAAh transmits an AAA-MIP-request message to the HA at step 1015.

The HA, which has received the MIP request message, transmits a HA-MIP-answer message to the AAAh at step 1017. The AAAh transmits the AAA-mobile node-answer message to the AAAf at step 1019. The AAAf retransmits the AAA-mobile node-answer message to the PDSN at step 1021.

Thereafter, the PDSN transmits an MIP registration reply to the MC at step 1023. Through this process, the MC transmits and receives data using the PPP session at step 1025. At this time, user data can go through an additional authentication process by the AAAh at step 1027.

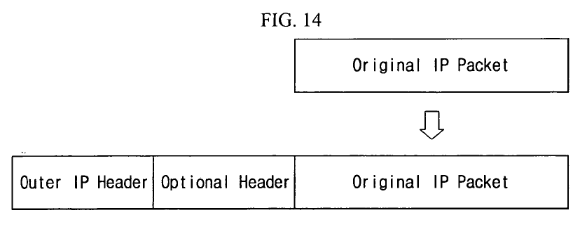

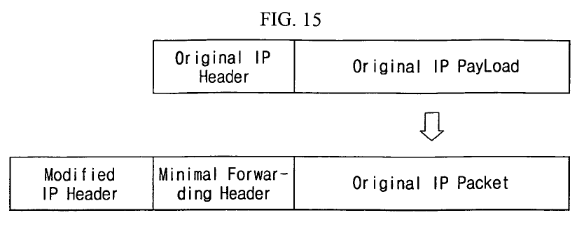

FIG. 14 is a diagram showing a data format for a general IP in IP encapsulation process. Furthermore, FIG. 15 is a diagram showing a data format for a general minimum encapsulation process. Referring to FIGS. 14 and 15, the personal information device according to an embodiment of the present invention may use a Co-located Care Of Address (CCOA) type MIP address when necessary, in addition to a Care Of Address (COA) type MIP address. In this case, the personal information device according to an embodiment of the present invention comprises a function of acting as an FA for IP in IP that is a kind of encapsulation or tunneling, as shown in FIG. 14.

In the case of the above-described COA, actual data packets, except for those in an early MIP setting process, are processed in the same manner as simple IP packets. That is, in the COA, the IP in IP processing process shown in FIG. 14 is performed in the FA and the HA. In the case of the COA, the FA has a mapping table for MIP addresses and simple IP addresses.

However, in the case of the CCOA, the processing process up to MIP setting is similar to the COA, and the processing process of the FA shown in FIG. 15 is made to be performed in the personal information device at the time of transmitting and receiving packets. Accordingly, in the case of the CCOA, the IP in IP processing is performed in the personal information device. As described above, the case of converting a general IP packet in the personal information device occurs in the CCOA manner. Of course, the above-described filter or program of an embodiment of the present invention can perform an IP in IP encapsulation process in the CCOA manner. Since this is apparent to those skilled in the art from the description of the present specification, a detailed description thereof is omitted.

Meanwhile, in the above-described embodiment, the CDMA modem, which is one of the wireless modems, has been described as an example. The present invention is not limited to the CDMA modem. For example, the present invention can be applied to a mobile communication terminal equipped with a W-CDMA wireless modem and a WLAN card.

The present invention is not limited to the above-described embodiments, and it is apparent that many variations are possible by those skilled in the art without departing from the concept of the present invention.

What is claimed is:

1. A method of controlling seamless vertical roaming in a personal information device equipped with a wireless modem and a Wireless Local Area Network (WLAN) device, the method comprising:
being assigned an Internet Protocol (IP) address by a Foreign Agent (FA) within an accessible WLAN using a Dynamic Host Configuration Protocol (DHCP) client, wherein the IP address is stored on a filter set on a physical layer and registered on a Domain Name Server (DNS) of the WLAN, which is currently being accessed, by the FA;
transmitting a Mobile IP (MIP) request message to the FA;
receiving a MIP advertisement message from the FA;
transmitting a MIP registration request message to the FA, wherein the FA transmits the MIP registration request message to a Home Agent (HA) and receives a first MIP address from the HA;
receiving the first MIP address from the FA, wherein the first MIP address is stored in the filter and the FA registers the first MIP address in the HA;
determining whether the personal information device has left a WLAN area (hot spot);
if, as a result of the determination, the personal information device has left the WLAN area, terminating an operation of the WLAN device and connecting a Point-to-Point Protocol (PPP) session with a Packet Data Serving Node (PDSN) within the WLAN using dial-up networking of the wireless modem at the same time; and
receiving a second MIP address from the PDSN, wherein the second MIP address is assigned by the HA to correspond to the first MIP address and stored in the filter, and the PDSN registers the second MIP address in the HA.

2. The method in claim 1, wherein the filter is set by a control client program that integrally operates the wireless modem and the WLAN device.

3. The method in claim 2, wherein the filter controls headers of data packets or IP packets, which are transmitted and received between the FA or PDSN and the personal information device, between the physical layer and an upper layer above the physical layer.

4. The method in claim 3, wherein the filter comprises a WLAN filter and a MIP filter set on the physical layer.

5. The method in claim 1, further comprising the step of the FA or PDSN requesting access authentication from an Authentication, Authorization and Accounting (AAA) or home AAA (AAAh) and receiving a response thereto at the time of receiving the MIP registration request message.

6. A method of controlling seamless vertical roaming in a personal information device equipped with a wireless modem and a WLAN device, the method comprising:
establishing a PPP session with a PDSN within a wireless network using dial-up networking;
receiving an HA advertisement message from the PDSN;
transmitting a MIP registration request message to the PDSN, wherein the MIP registration request message is transmitted to the HA through a foreign AAA (AAAf) and an internal AAA (AAAh);
receiving a MIP registration reply message from the PDSN, wherein the MIP registration reply message comprises a first MIP address assigned by the HA, the first MIP address is stored in a filter set on a physical layer, and the PDSN registers the first MIP address in the HA;
determining whether the personal information device exists in a WLAN area (hot spot) in a wireless network access state;
if, as a result of the determination, the personal information device exists in the WLAN area, terminating an operation of the wireless modem and being assigned an available IP address from an FA within the WLAN using a DHCP client of the WLAN device at the same time, wherein the IP address is stored in the filter and is registered in a Domain Name Server (DNS) of the WLAN, which is being currently accessed, by the FA; and
receiving a second MIP address from the FA, wherein the second MIP address is assigned by the HA to correspond to the first MIP address and stored in the filter, and the FA registers the second MIP address in the HA.

7. The method in claim 6, wherein the filter is set by a control client program that integrally operates the wireless modem and the WLAN device.

8. The method in claim 7, wherein the filter controls headers of data packets or IP packets, which are transmitted and received between the FA or PDSN and the personal information device, between the physical layer and an upper layer above the physical layer.

9. The method in claim 8, wherein the filter comprises a WLAN filter and a MIP filter set on the physical layer.

10. The method in claim 6, further comprising the step of the FA or PDSN requesting access authentication from an AAA or an AAAh and receiving a response thereto at the time of receiving the MIP registration request message.

11. A computer readable recording medium having stored thereon a computer executable control client program for integrally operating a wireless modem and a WLAN device to perform automatic seamless roaming between a wireless network and a WLAN, the control client program executing a method comprising:
being assigned an IP address by an FA within an accessible WLAN using a DHCP client, wherein the IP address is stored on a filter set on a physical layer and registered on a DNS of the WLAN, which is currently being accessed, by the FA;
transmitting a MIP request message to the FA;
receiving a MIP advertisement message from the FA;
transmitting a MIP registration request message to the FA, wherein the FA transmits the MIP registration request message to a HA and receives a first MIP address from the HA;
receiving the first MIP address from the FA, wherein the first MIP address is stored in the filter and the FA registers the first MIP address in the HA;
determining whether the personal information device has left a WLAN area (hot spot);
if, as a result of the determination, the personal information device has left the WLAN area, terminating an operation of the WLAN device and connecting a PPP session with a PDSN within the WLAN using dial-up networking of the wireless modem at the same time; and
receiving a second MIP address from the PDSN, wherein the second MIP address is assigned by the HA to correspond to the first MIP address and stored in the filter, and the PDSN registers the second MIP address in the HA.

12. A computer readable recording medium having stored a computer executable control client program for integrally operating a wireless modem and a WLAN device to perform automatic seamless roaming between a wireless network and a WLAN, the control client program executing a method comprising:
establishing a PPP session with a PDSN within a wireless network using dial-up networking;
receiving a HA advertisement message from the PDSN;
transmitting a MIP registration request message to the PDSN, wherein the MIP registration request message is transmitted to the HA through an AAAf and an AAAh;
receiving a MIP registration reply message from the PDSN, wherein the MIP registration reply message comprises a first MIP address assigned by the HA, the first MIP address is stored in a filter set on a physical layer, and the PDSN registers the first MIP address in the HA;
determining whether the personal information device exists in a WLAN area (hot spot) in a wireless network access state;
if, as a result of the determination, the personal information device exists in the WLAN area, terminating an operation of the wireless modem and being assigned an available IP address from an FA within the WLAN using a DHCP client of the WLAN device at the same time, wherein the IP address is stored in the filter and is registered in a DNS of the WLAN, which is being currently accessed, by the FA; and
receiving a second MIP address from the FA, wherein the second MIP address is assigned by the HA to correspond to the first MIP address and stored in the filter, and the FA registers the second MIP address in the HA.
